(19) United States
(12) Patent Application Publication
(10) Pub. No.: US 2002/0035787 A1
(43) Pub. Date: Mar. 28, 2002

(54) Haircutting tool with superimposed blades

(76) Inventor: Mario Stagi, Camaiore (Lucca) (IT)

Correspondence Address: BROWDY AND NEIMARK, P.L.L.C., 624 NINTH STREET, NW, SUITE 300, WASHINGTON, DC, 20001-5303, US

(21) Appl. No.: 09/953,304

(22) Filed: Sep. 17, 2001

(30) Foreign Application Priority Data
Sep. 28, 2000 (IT) PI2000U000035

(51) Int. Cl. B26B 13/00

(52) U.S. Cl. 30/226

(57) ABSTRACT

A haircutting tool comprising in which the cutting means, extending from grip means (6, 8), coaxially thereto, comprise at least one V-shaped cutting front (F) defined by at least one couple of outer blades (2, 4), at least one outer blade (2, 4) being pivotable with respect to the grip means (6, 8). Means (11) for driving the at least one outer pivotable blade are fit to be operated in order to adjust the angle of said at least one V-shaped cutting front (F).

### FIELD OF THE INVENTION

The present invention relates to the field of the professional equipment for haircutting, and namely it refers to a new type of cutting tool.

### BACKGROUND OF THE INVENTION

Many cutting tools and methods are known, used by hairdressers in their professional practice. The choice of a particular tool and/or cutting technique depends on the type of haircut one wishes to obtain, and also on the skills and inclinations of the individual hairdresser.

The most traditional tools are the common scissors, with two blades having straight cutting edges or provided with variously shaped and sized teeth. In use, the typical cutting action provides that the operator seizes and stretches a tuft of hair with two fingers, while the other hand, holding the scissors, cuts the tuft by closing the two blades. If the scissors have straight cutting edges, the cut of the tuft will be clear and uniform. On the contrary, if the edges are toothed, only a part of the tuft, i.e. that which are affected by the contact with the teeth, will be cut.

The razor is another tool that is widely used by hairdressers. In its conventional configuration, the razor has a single blade, of which the edge is remarkably sharper than those of the scissors. The razor makes it possible to perform the technique for obtaining the so-called “layered tuft”. According to such cutting technique, the operator drives the razor axially, at the same time suitably adjusting the radial friction between the blade and the tuft. In this way, by exerting a stronger friction in the initial phase of the cutting movement and a weaker one in the final phase, it is possible to obtain a tuft in which some hairs are remarkably shorter than others, thus accomplishing particular hairstyles. This result can not be obtained by using the scissors, with which the cut is always clear and outlined according to a fixed geometry and as a consequence the operator can not thin the tuft out variably—as mentioned above—unless innumerable subsequent cuts are carried out.

Nevertheless, the use of the razor involves some significant drawbacks. In particular, it is very difficult, especially for inexperienced operators, to have a precise control of the angle between the edge of the blade and the axis of the tuft, as a function of the effect one wishes to achieve. Namely, it is very hard for the operator to keep said angle constant irrespective of the variation of the part of the hair on which he/she is working, as required in many circumstances.

Besides, mainly for the defective handiness of the tool, it is troublesome to accurately adjust the radial friction on the tuft, as a function of the specific result to be obtained. For the same reason, the cutting operations are relatively tiring and time consuming. On the other hand, this latter drawback is also due to the poor productivity of the tool, i.e. the small amount of hair that is affected by each cutting movement.

Even disregarding the above-mentioned drawbacks, the following problem—intrinsically related to the cutting action performed by the razor—is probably even more relevant. In fact, when the blade of the razor shifts as described above, the surface of the hairs is extensively peeled, and as a result the hairs are devitalized and made dull. This entails both esthetical and medical negative consequences.

According to the above explanations, it will be actually impossible to make the tuft jagged, that is to give the relevant hairs a length that varies in a completely random way. This because with the razor the tuft is regularly thinned out, i.e. hairs linearly become longer moving along the axis of the tuft.

### SUMMARY OF THE INVENTION

The main object of the present invention is to overcome such drawbacks, by providing a haircutting tool which, thanks to an original configuration of its components, permits to carry out the layered cutting technique in an effective and precise way, with a better control of the cutting action and with increased comfort and operation quickness.

A particular object of the present invention is to provide a tool of the above-mentioned type with which jagged tuft can be obtained, according to an effectiveness which is unachievable by the currently available tools.

Such objects are accomplished with the haircutting tool according to the present invention, comprising grip means and cutting means extending from said grip means, coaxially thereto, said cutting means comprising at least one V-shaped cutting front defined by at least one couple of outer blades, at least one of said outer blades being pivotable with respect to the grip means, means for driving said at least one outer pivotable blade being also provided, said driving means being fit to be operated in order to adjust the angle of said at least one V-shaped cutting front.

### BRIEF DESCRIPTION OF THE DRAWINGS

Features and advantages of the haircutting tool according to the present invention will be made clearer hereinafter with the following description of embodiments thereof, made by way of example and not limitative, with reference to the attached drawings in which:

FIG. 1 shows a side view of a first embodiment of the tool according to the invention;

FIG. 2 is a cross-section of the tool taken along lines II-II of FIG. 1;

FIG. 3 is a cross-section of the tool taken along lines III-III of FIG. 1; and

FIG. 4 is a side view of a second embodiment of the tool according to the invention.

### DETAILED DESCRIPTION OF THE PREFERRED EMBODIMENTS

With reference to figures from 1 to 3, the tool according to the invention, in a first embodiment, comprises a central blade 1 shaped as a isosceles triangle, with two skew cutting edges 1a, straight and very sharp, symmetrically departing from a rounded tip 1b. The cross-section of blade 1 is outlined according to a parallelogram (as clearly shown in FIG. 3), defined by two mutually opposite shoulder faces 1c, and two mutually opposite sharpening faces 1d, cutting edges 1a being generated by a shoulder face 1c and a sharpening face 1d consecutive to each other.

The end which is opposite to that forming tip 1b of central blade 1 is integrally connected to a foot, preferably—as in the depicted example—having the shape of a disk 3, of which the bases 3a, shown in FIG. 2, are coplanar to respective shoulder faces 1c of blade 1 itself. A grip arm 6 projects from the side surface 3b of disk 3, integrally as well and in a opposite direction with respect to blade 1. The free end of arm 6 forms a ring 8 substantially coplanar to disk 3. More precisely, arm 6 comprises a root 6a projecting from disk 3 in a substantially tangential direction, and proceeds with a curved stem 6b which tangentially joins ring 8, the latter being substantially lined-up with central blade 1.

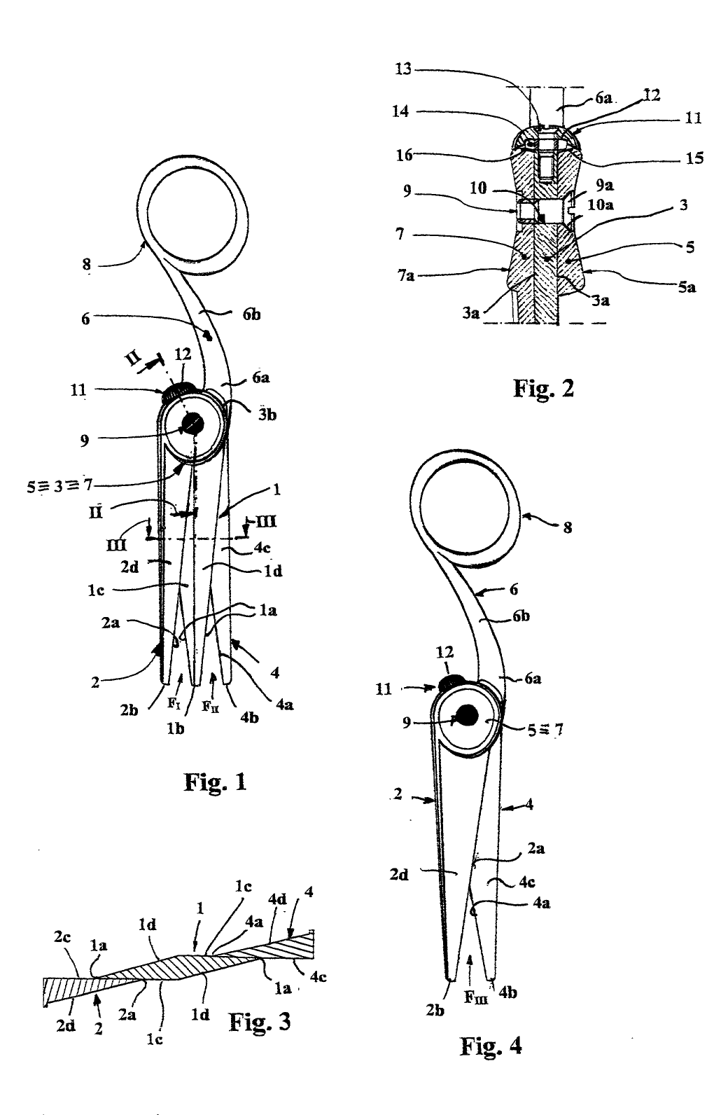

Two outer blades 2, 4 are placed on respective shoulder faces 1c of central blade 1 and are supported by disk 3 via further disks 5 and 7, according to what will be made clearer hereinafter. Outer blades 2, 4 have a triangular shape which substantially corresponds to a half of the central blade 1, with respective sharp edges 2a, 4a, opposite to each other and symmetrically converging from rounded tips 2a, 4b towards the axis of central blade 1. In this way, a couple of V-shaped cutting fronts, indicated at F_{I} and F_{II} in FIG. 1, are defined by edges 2a, 4a in cooperation with the two edges 1a of blade 1.

In greater detail, outer blades 2, 4 have each a triangular cross-section, formed by shoulder faces 2c, 4c, adjacent to corresponding shoulder faces 1c of central blade 1 and by oblique sharpening faces 2b, 4b which, joining shoulder faces 2c, 4c generate cutting edges 2a, 4a.

As mentioned, the two outer blades 2, 4 have respective disk-shaped foots 5 and 7, corresponding to disk 3 of central blade 1 and connected thereto on respective bases 3a. As shown in particular in FIG. 2, the mutual connection between the three disks 3, 5 and 7 is carried out via a screw 9, secured within a seat 10 axially formed therein. Seat 10 is screwed in correspondence to one of the outer disks, in the example disk 7, and has a flared portion 10a on the other outer disk 5, for the axial abutment of a head 9a of screw 9. In correspondence to central disk 3, screw 9 and seat 10 are coupled with a close running fit.

Thanks to the above described configuration, the two outer disks 5 and 7, and consequently the two outer blades 2 and 4, if operated with a certain strength, pivot with respect to central blade 1 about the common axis of the three superimposed disks, thus enlarging or narrowing the angle of cutting fronts F_{I} and F_{II}. Such operation is driven—in a coordinate manner for the two outer blades 2, 4—by an adjustment mechanism 11, shown in FIG. 2 as well.

Mechanism 11 comprises a revolving operation crown 12, radially projecting from central disk 3 and supported thereby via a screw 13. Crown 12 coaxially bears a cone-shaped gear 14 which, engaging with complementary cone-shaped gears 15 and 16 formed in outer disks 5 and 7 respectively, so that the rotation of the crown about its own axis drives the rotation of the two outer blades 2, 4 about the common axis of the three superimposed disks.

In use, the tool is gripped by the operator by inserting the forefinger or the middle finger of a hand within ring 8, and simultaneously placing the tip of the thumb on the outer face of one of the outer disk. In order to provide an easier and safer support to the fingertip, said faces preferably form respective cavities 5a, 7a, as in the depicted embodiment (see FIG. 2).

The cutting operation which can be accomplished in this way is substantially analogous to that according to the layered technique carried out by means of a common razor. However, in this case a fundamental advantage consists in the fact that, after a suitable preliminary adjustment of the angle of the cutting fronts F_{I} and F_{II}, it is possible to effectively control the angle with which the hair tuft is affected by the cutting edges, keeping this angle constant, when required, irrespective of the variation of the part of the hair on which the operator is working.

In greater detail, a typical cutting procedure which can be carried out with the tool provides that, after adjusting and fixing the angle of the cutting fronts, a first tuft to be cut is chosen. This tuft is stretched with the fingers of the free hand. Then, the tuft is struck by means of the tool with quick and repeated cutting movements all around and along the tuft itself. Said movements are always guided from above, normally and/or obliquely with respect to the axis of the tuft.

After operation on a first tuft, a subsequent, closely higher one is picked and superimposed to the first, which is taken as a reference for the subsequent cutting action. Thanks to such technique, repeated for a number of subsequent tufts, one can make all the parts of the hair mutually proportioned and harmonized, in a much more easy way than with the procedure according to known techniques.

When driven towards the end of the tuft, the tool creates a number of pointed portions which, together with similar portions of the tufts which were previously cut, result in a jagged profile, while not damaging the surface of the hairs. Thus, the hair will be stably modeled according to the most various aesthetic needs, for obtaining a straight and compact hair dress or a voluminous one, the tufts sustaining each other via the pointed portions generated by the tool. Moreover, jagged outlines will be created with the object of obtaining particularly dynamic and fanciful dresses, of which the young customers are especially fond of.

As to the adjustment of the angle according to the specific cutting needs, in order to ensure a suitable adaptability of the tool it is sufficient that the gearing between crown 12 and outer disks 5, 7 is fit to control a rotation of the two outer blades 2, 4 of about 10°.

Besides, the ease and quickness of the cutting operation is assisted by the comfort of the grip, and by the fact that two distinct V-shaped cutting fronts are at work in a single cutting movement. However, this latter aspect does not imply an essential feature of the invention, since, in order to comply with particular handiness and precision requirements, it is possible to benefit from an embodiment which provides a single V-shaped cutting front.

Such an embodiment is shown in FIG. 4, in which parts corresponding to those of the first embodiment are indicated at the same reference numerals. In the depicted example, basically, central blade 1 and relevant disc 3 are not present, and the two outer blades 2, 4 define with respective edges 2a, 4a a single V-shaped cutting front F_{III}, said blades directly contacting each other via respective shoulder faces. Grip arm 6 projects from one of the outer disks, namely disk 7, which also supports driving mechanism 11 with operation crown 12.

Therefore, in this case an outer blade 4 is integral to the grip, and mechanism 11 drives the other outer blade 2, so that the latter can pivot adjustably. A substantially analogous result can be achieved if disk 3 is maintained as a support for mechanism 11. The latter, as in the first embodiment, will drive both outer blades 2, 4, which contact each other due to the absence of central blade 1.

On the other hand, in a still different embodiment of the invention a tool is provided in which the stable central blade is a multiple one, i.e. a blade which, by means of two supplementary inwards cutting edges, forms a central V-shaped cutting front, having an unchanging angle, in addition to the two variable-angle cutting fronts generated by the same blade in cooperation with the adjustable outer blades. Such a tool will be useful for those cutting operations in which the maximum productivity is required.

Other variations and/or modifications can be brought to the haircutting tool with superimposed blades according to the present invention, without departing from the scope of the invention itself. Namely, the mechanism for adjusting the angle of the outer blades may be different from the one described above, provided that it can perform the same function. In an analogous manner, the grip of the tool may be shaped differently.

1. A haircutting tool comprising grip means (6, 8) and cutting means extending from said grip means, coaxially thereto, said cutting means comprising at least one V-shaped cutting front (F) defined by at least one couple of outer blades (2, 4), at least one of said outer blades (2, 4) being pivotable with respect to said grip means (6, 8), means (11) for driving said at least one outer pivotable blade (2, 4) being also provided, said driving means (11) being fit to be operated in order to adjust the angle of said at least one V-shaped cutting front (F).

2. A tool according to claim 1, comprising a couple of outer pivotable blades (2, 4), hinged to said grip means (6, 8), said driving means (11) controlling both said pivotable blades (2, 4).

3. The tool according to claim 2, in which a central blade (1) integrally projects from said grip means (6, 8), said central blade (1) comprising a couple of opposite shoulder faces (1c) forming respective cutting edges (1a), said shoulder faces (1c) contacting shoulder faces (2c, 4c) of respective outer pivotable blades (2, 4), forming respective cutting edges (2a, 4a), whereby two V-shaped cutting fronts (F_{I}, F_{II}) are defined.

4. The tool according to claim 3, in which a further V-shaped cutting front, having a fixed angle, is defined by said central blade (1) via two supplementary inwards cutting edges.

5. The tool according to claim 1, comprising a couple of outer blades (2, 4), a blade (4) being integral to said grip means (6, 8) and pivotably supporting the other blade (2), said blades (2, 4) mutually contacting via respective shoulder faces (2c, 4c) forming respective cutting edges (2a, 4a), whereby a single V-shaped cutting front (F_{III}) is defined, said driving means (11) being associated to the fixed blade (4) for controlling the pivotable blade (2).

6. The tool according to claim 2, in which said blades (1, 2, 4) integrally project from respective disc-shaped feet (3, 5, 7), mutually superimposed, said blades being mutually connected via said feet.

7. The tool according to claim 6, in which said grip means comprise an arm (6) having a root (6a) tangentially projecting from one of said disc-shaped feet and a curved stem (6b) ending in a ring (8) which is substantially coplanar to the relevant foot, said ring and said foot being lined-up according to a central axis of the tool.

8. The tool according to claim 7, in which a cavity (5a, 7a) is formed in an outer face of at least one of said feet (5, 7), in order to assist the grip of the tool.

9. The tool according to claim 6, in which said driving means (11) comprise a revolving crown (12), radially projecting from one of said feet (3, 5, 7) and engaging via gear means (14, 16) with at least one pivotable blade (2, 4) in order to control its rotation.

10. The tool according to claim 9, in which said gear means (14, 16) are arranged in order to control the coordinate rotation of a couple of pivotable blades (2, 4).

11. The tool according to claim 3, in which said blades (1, 2, 4) integrally project from respective disc-shaped feet (3, 5, 7), mutually superimposed, said blades being mutually connected via said feet.

12. The tool according to claim 11, in which said grip means comprise an arm (6) having a root (6a) tangentially projecting from one of said disc-shaped feet and a curved stem (6b) ending in a ring (8) which is substantially coplanar to the relevant foot, said ring and said foot being lined-up according to a central axis of the tool.

13. The tool according to claim 12, in which a cavity (5a, 7a) is formed in an outer face of at least one of said feet (5, 7), in order to assist the grip of the tool.

14. The tool according to claim 11, in which said driving means (11) comprise a revolving crown (12), radially projecting from one of said feet (3, 5, 7) and engaging via gear means (14, 16) with at least one pivotable blade (2, 4) in order to control its rotation.

15. The tool according to claim 14, in which said gear means (14, 16) are arranged in order to control the coordinate rotation of a couple of pivotable blades (2, 4).

16. The tool according to claim 5, in which said blades (1, 2, 4) integrally project from respective disc-shaped feet (3, 5, 7), mutually superimposed, said blades being mutually connected via said feet.

17. The tool according to claim 16, in which said grip means comprise an arm (6) having a root (6a) tangentially projecting from one of said disc-shaped feet and a curved stem (6b) ending in a ring (8) which is substantially coplanar to the relevant foot, said ring and said foot being lined-up according to a central axis of the tool.

18. The tool according to claim 17, in which a cavity (5a, 7a) is formed in an outer face of at least one of said feet (5, 7), in order to assist the grip of the tool.

19. The tool according to claim 16, in which said driving means (11) comprise a revolving crown (12), radially projecting from one of said feet (3, 5, 7) and engaging via gear means (14, 16) with at least one pivotable blade (2, 4) in order to control its rotation.

20. The tool according to claim 19, in which said gear means (14, 16) are arranged in order to control the coordinate rotation of a couple of pivotable blades (2, 4).
